(19) United States
(12) Patent Application Publication
(10) Pub. No.: US 2003/0036344 A1
(43) Pub. Date: Feb. 20, 2003

(54) Method and apparatus for cutting objects

(75) Inventors: Arni Geir Sigurdsson, Seltjarnarnes (IS); Arni Sigurdsson, Mosfellsbaer (IS); Ragnar Sverrisson, Reykjavik (IS); Hordur Arnarson, Reykjavik (IS)

Correspondence Address: PILLSBURY WINTHROP, LLP, P.O. BOX 10500, MCLEAN, VA, 22102, US

(73) Assignee: MAREL HF

(21) Appl. No.: 10/270,666

(22) Filed: Oct. 16, 2002

Related U.S. Application Data
(63) Continuation of application No. 09/830,023, filed on Jun. 14, 2001, now abandoned.
Application No. 09/830,023 is a 371 of international application No. PCT/IS99/00012, filed on Oct. 20, 1999.

(30) Foreign Application Priority Data
Oct. 20, 1998 (IS) 4875

(51) Int. Cl. A22C 25/14; A22C 25/18; A22C 25/20

(52) U.S. Cl. 452/150

(57) ABSTRACT

The invention concerns apparatus and method for automatic cutting of objects into portions of reduced dimension. More specifically the invention concerns a cutting device (9) placed horizontally over a transporting conveyor (3). The cutting device is further operatively connected to a computer (6) and moveable in an up- and downward direction with respect to the conveyor. The characteristics of the object to be cut are determined. By utilising at least one of the characteristics to establishing the desired cutting pattern one is able to cut the object into portions of predetermined thickness by band saw cutting blade (7).

### TECHNICAL FIELD OF THE INVENTION

The present invention concerns apparatus and method for automatic cutting of objects into portions of reduced dimensions. More specifically the invention involves utilizing a horizontal cutting device placed above a transporting conveyor. The cutting device being operatively connected to a computer and moveable in the area above the conveyor.

### BACKGROUND OF THE INVENTION

It is well known that food such as fish and meat is sold and later served in predetermined portions (on the basis of weight, shape or other dimensions). This is the case with both the catering and the household sectors. Production of such fish and/or meat portions was previously performed by manual cutting, but various accessories and portion cutting machines have been developed in recent years. Studies have shown that manual portion cutting of fish fillets into predetermined sizes and shapes can yield a deviation in portion size of up to 10%, if no special methods are employed to increase the accuracy of manual cutting. In all probability, therefore, the producer receives a lower price per unit weight for the raw material input as weighed in comparison to what he would receive if he could reduce the deviation from the negotiated weight.

One of the problem in automatic cutting meat, such as fish or poultry into portions, is that it has only been possible to achieve vertical straight line cuttings, either transversal- or longitudinal cuts. The cutting means known are circular knives for cutting either transversally or longitudinally through the object, but performing the cut above the means conveying the object to be cut. In U.S. Pat. No. 4,557,019 one such method and equipment is described for automatic control of portion cutting of fish.

In European patent no. 504,446 a method and equipment for automatic portion cutting of fish or meat is also described. More specifically, the patent describes automatic portion cutting equipment whereby the fish or meat portions are cut transversally by a sword like cutting device.

U.S. Pat. No. 4,875,254 describes a method and equipment for determining the volume, form, and weight of fish transported on a conveyor and cutting the fish by water jet cutter. By the water jet cutter it is possible to cut the fish longitudinally as well as transversally.

Further U.S. Pat. No. 4,868,951 describes a apparatus and method for obtaining a portion of predetermined weight by cutting the object by a circular cutting knife. The cutting blade is arranged longitudinally along the conveying direction of the object.

Modern food processing demands high levels of productivity and precision. It is the aim of the producer and requests of the buyer to obtain as accurate portion size as possible. It is also an important factor that the objet in this case, fish or meat portions have a certain configurations and/or thickness due to the end buyers requests. It is also required in many instances to perform both transverse and longitudinal, as well as curved cuttings to achieve the required portion sizes/configuration. Enhanced processing technology would lead to much better utilization of raw material and thus cost-effectiveness of processing.

The main disadvantage of the known prior art is that it has not been possible to achieve horizontal cuts on a continuous conveyor in an economical and effective manner. The cutting by circular rotating cutting device placed above the conveyor path has not given the result expected. It has been very difficult to cut horizontally through the object without having problems with the conveyor transporting the object. Further it is very difficult to achieve the horizontal cutting as the cutting is extended over such long portion of the meat.

### DESCRIPTION OF THE INVENTION

The aim of the invention is to present apparatus and method for controlling automatic cutting of objects into portions of reduced dimensions, especially thickness by utilizing cutting device and method which is able to cut the object horizontally in effective and economical manner.

This aim of the invention is achieved by providing an apparatus where the cutting device being a cutter having a cutting edge extending horizontally over the transporting path of the object, the height of the cutting edge being adjustable according to characteristics of the object, and thereby the object being cut into portions of predetermined reduced dimension/thickness on the conveyor.

The aim of the invention is also achieved by providing a cutter that is a continuous band-saw blade cutter. The cutting edge/blade is aligned according to a cutting thickness of the object. The band saw cutter is further equipped with a cutting supporting device arranged over the conveyor for holding the object in position during the cutting operation. The named supporting device is a conveyor belt forming a grip for holding the object during the cutting. One variation of the invention describes arranging a plurality of individually moveable band-cutters spaced apart in over the conveyor.

Finally, the aim of the invention is achieved by providing means for determining the dimensions of the objects comprises imaging equipment. The imaging equipment being a line scan camera or a structural light frame camera device. Further the means for determining the characteristic properties of the objects being a weighing device. The weighing device, being an in- and/or out-weighing conveyor platform. Finally the imaging equipment being means for locating non wanted properties in the object or means for determining qualitative properties of the object such as fat/meat ratio, or collar detecting device.

In accordance with a method of the present invention which utilise the described band saw cutter the following steps are performed: conveying a present object to be cut; determining/measuring the characteristic properties of said object to be cut; utilising at least one of the characteristics determined/measured to establishing the desired cutting pattern; cutting the object based on said determined/measured characteristic of the object; said cutting being performed by band saw cutting blade; the cutting blade extending through the conveying path of the object; the cutting blade being moveable/adjustable vertically with respect to the conveying plan of the object, and thereby cutting the objects into portions of predetermined reduced dimension/thickness as the objects are conveyed along said conveyor/conveying direction.

### BRIEF DESCRIPTION OF THE DRAWINGS

In the following the invention is described in more details with reference to the drawings; in which

FIG. 1 is a side view of the principal setup of the apparatus;

FIG. 2 is a perspective view of the principal set-up of the apparatus;

FIG. 3 is a principal perspective view of the cutting unit of the apparatus;

### MORE DETAILED DESCRIPTION OF THE DRAWINGS AND

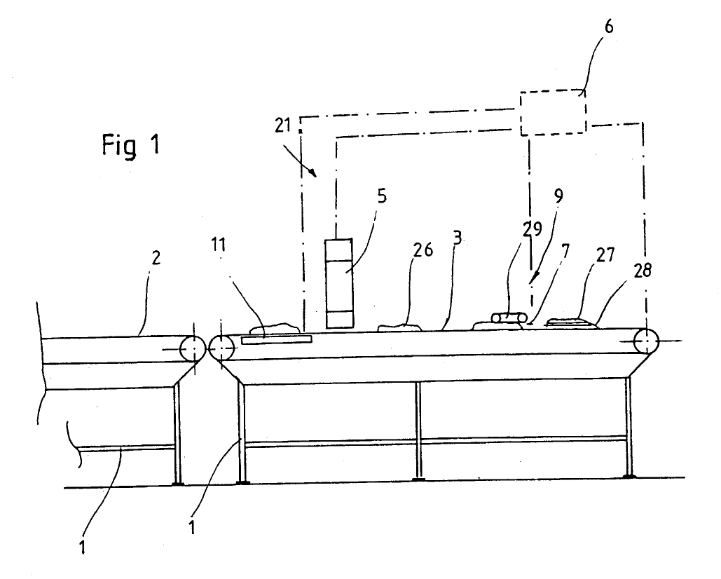

FIG. 1 shows a side view of the principal setup of the portioning apparatus, generally referred to at the figures as number 21. The objects (26) to be cut are placed on a conveyor (2, 3), which can be of any known type. In the present invention, the conveyor comprises a plurality of conveyors longitudinally aligned end-to-end with the other. The first conveyor belt (2) in which the object to be cut is placed. The first conveyor belt (2), transport the objects to be cut to a cutting device (9) placed in the area above the second conveyor (3). Prior thereto or even as the object is transported on the first conveyor the object is measured/detected, as to determine one or more characteristics of the object. Such determination can be done by weighing by any known art of conveyor weighing means (11), such as load cell. Such determination can also be done by image measurement (5) of the object where series of images of the object are recorded as image data. Preferably, the image equipment is made in accordance with U.S. Pat. No. 5,184,733, which is here incorporated as a reference. The image equipment could also be any kind of known so called structural frame camera, or imaging equipment for locating such characteristics as fat/meat ratio or non-wanted parts. Such non-wanted parts could be bones or other foreign articles. A combination of weighing and imaging is of course one of the options.

The image data is any kind of such information, although most preferred any dimensional information for the object to be cut that can be used by the computer system, referred to on the drawings as number 6. The dimensional information can be either the actual weight measured or calculated weight, calculated on the bases of length/width/height measurement of the object. As further defined in the patent claims, the imaging means, or the means for determining the characteristics of the object can be of any known type. Such could be line scan, or frame camera taking picture of the configuration (length, height, width) of the object. As also mentioned weighing the object can also be one way of obtaining the required data for the cutting.

The computer system (6) receive signals from the imaging and/or the weighing equipment and based thereupon, estimate/calculates characteristics of the object to be cut and instruct the cutting unit (9) accordingly.

As the object is conveyed further along the conveyor (3) it will reach the area where the horizontal cutting unit (9) is arranged. The cutting unit herein described and preferred is a band-saw-cutter (7) extending substantially horizontally and transverse over the conveyor (3). The object is to be cut transverse along its longitudinal axis as it is conveyed through the cutting unit (9). The band-saw cutter (7) is height adjustable with respect to the conveyor plane. By moving or adjusting the band-saw-cutter height, one will be able to achieve two things. Firstly, by moving the cutter in or out of the cutting path of a particular object no movement of the object is required and it is no reason to align each and every object according to the placement of the cutter. Secondly, by adjusting the height of the cutting unit one can achieve different thickness cuttings.

Pre-input parameters and/or calculated measurements of the velocity of the conveyor belts, and thus the speed at which the object passes through the equipment, are also input to the computer system (6). The velocity of the conveyor belts and image taken by the imaging equipment can be used by the computer system to determine the relative position of the object to be cut on the conveyor. Alternatively, the use of encoders, sensors, or combination thereof, can also be used to determine the relative position of the object to be cut on the conveyor. The relative position of the object to be cut is sent to the computer system (6). By increasing or decreasing the speed of the conveyors one can influence the performance of the cutting, especially when cutting different thickness/width it can be preferred to increase/decrease the speed of the conveyor temporarily. The computer system (6) then transmits data to a cutting device (9) operatively connected thereto. The cutting device (9) cuts the object at locations based on the estimated weight or other measured/detected characteristics or calculated by the computer. From the second conveyor (3), the objects can alternatively be transported onto a third conveyor belt (not shown) across an out-weigher (not shown), where each individual portioned part of the object is weighed before being transported for further processing, or for grading by the grading equipment (not shown).

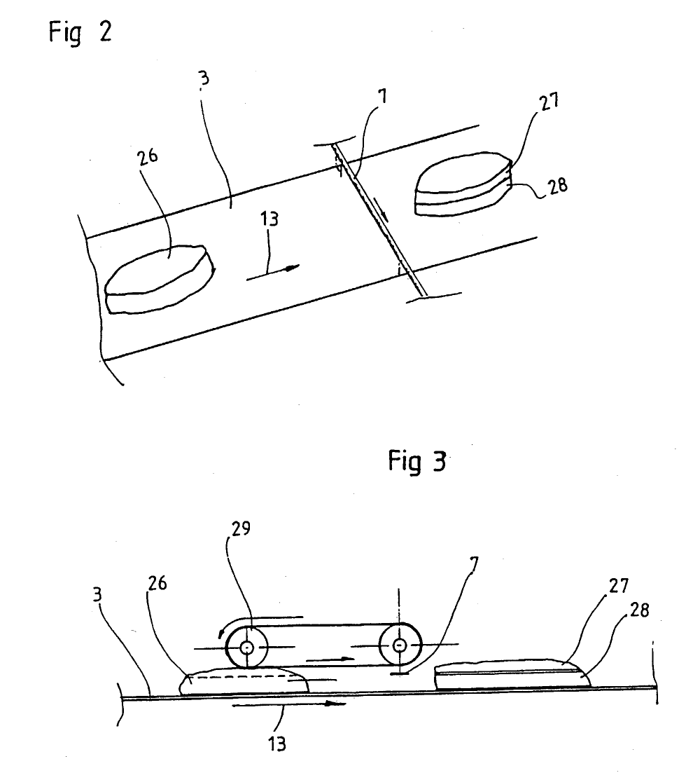

FIG. 2 and 3 shows the principal design of the equipment seen from above and the side. On the conveyor (3) uncut objects (26) are shown. After the cutting device (7) a transversally cutted objet (27, 28) is also illustrated.

FIG. 2 shows a perspective view of the band-saw cutting device (9) of the apparatus. The band saw cutting blade (7) is arranged perpendicular and transversal horizontally aligned with the conveyor (3). The band, extend substantially horizontally and transversal over conveyor. The band-saw cutting device (7) can bee any kind of cutting device having a blade that can extend through the object to cut. Such can be traditional endless band saws, with teethed or knife like cutting edge. A string can also be used, as well as jig- or stitch saws or similar.

It thus will be appreciated that the objects of the present invention have been fully and effectively accomplished. It will be realized, however, that the foregoing preferred specific embodiment has been shown and described for the purpose of this invention and are subject to change without departure from its basic principles. Therefore, this invention includes all modifications and equivalents encompassed within the spirit and scope of the following claims.

1. Apparatus for automatic cutting of objects into portions of reduced dimension, comprising:
a frame (1);
a conveyor (2, 3) on the frame (1) for transporting the objects along a transporting path (13) in downstream direction;
device (5, 11) for determining the characteristics of the objects;
a computer system (6) interacting with the device (5, 11) for determination of the characteristics of the object;
a cutting device (9) on the frame (1) for cutting the objects into portions, said cutting device (9) being operatively connected with the computer system (6),
characterised in that;
said cutting device (9) being a cutter (7) having a cutting edge extending horizontally over the transporting path (13) of the object, the height of the cutting edge being adjustable according to characteristics of the object, and thereby the object being cut into portions of predetermined reduced dimension/thickness on the conveyor (3).

2. The apparatus according to claim 1, characterised in that, the band-saw-cutter (7) being a continuous band-saw blade cutter.

3. The apparatus according to claim 1 or 2, characterised in that, the cutting edge/blade being aligned according to the thickness of the object.

4. The apparatus according to claim 1, 2 or 3, characterised in that, the band saw cutter (7) being equipped with a cutting supporting device (29) arranged over the conveyor for holding the object in position during the cutting.

5. The apparatus according to any of the preceding claims, characterised in that, the supporting device (29) being a conveyor belt, the supporting device (29) and the conveyor (3) forming a gripping element holding the object there between during the cutting.

6. The apparatus according to any of the preceding claims, characterised in that a plurality of individually moveable band-cutters (7) are arranged spaced apart over the conveyors.

7. The apparatus according to claim 1, characterised in that, the means (5) for determining the dimensions of the objects comprises imaging equipment.

8. The apparatus according to claim 7, characterised in that, the imaging equipment being a line scan camera.

9. The apparatus according to claim 7, characterised in that, the imaging equipment being a structural light frame camera device.

10. The apparatus according to claim 1, characterised in that, the means for determining the characteristic properties of the objects being a weighing device (11).

11. The apparatus according to claim 10, characterised in that, the weighing device being an in- or out-weighing conveyor platform.

12. The apparatus according to claim 11, characterised in that, the weighing device being an in- and out-weighing platform.

13. The apparatus according to claim 1, characterised in that, the imaging equipment being means for locating non wanted properties in the object.

14. The apparatus according to claim 1, characterised in that, imaging equipment being means for determining qualitative properties of the object such as fat/meat ratio, or collar detecting device.

15. Method for automatic cutting of objects into portions of reduced dimension, comprising the step of:
conveying a present object to be cut;
determining/measuring the characteristic properties of said object to be cut;
utilising at least one of the characteristics determined/measured to establishing the desired cutting pattern;
cutting the object based on said determined/measured characteristic of the object;
said cutting being performed by band saw cutting blade;
the cutting blade extending horizontally over the conveying path of the object;
the cutting blade being moveable/adjustable vertically with respect to the conveyor plane,
thereby cutting the objects into portions of predetermined reduced dimension/thickness as the objects are conveyed along said conveyor/conveying direction.

16. The Method according to claim 15, characterised in that the height of the cutting device is adjustable according to the cutting curve determined for the particular object.
